(19) United States
(12) Patent Application Publication
(10) Pub. No.: US 2024/0331667 A1
(43) Pub. Date: Oct. 3, 2024

(54) ELECTRONIC APPARATUS, SOUND DATA DETERMINATION METHOD, AND NON-TRANSITORY COMPUTER READABLE MEDIUM

(71) Applicant: Roland Corporation, Shizuoka (JP)

(72) Inventor: Naoto Soga, Shizuoka (JP)

(73) Assignee: Roland Corporation, Shizuoka (JP)

(21) Appl. No.: 18/604,486

(22) Filed: Mar. 13, 2024

(30) Foreign Application Priority Data
Mar. 29, 2023 (JP) 2023-052758

(51) Int. Cl. G10H 1/00

(52) U.S. Cl. CPC G10H 1/0066; G10H 1/0008; G10H 2210/295; G10H 2240/311

(57) ABSTRACT

For sound data input from a disk drive 50, a PC 51, and a portable terminal (input source) 52, left and right channels are respectively set to “input system”, and a sound data determination is sequentially performed for each input system. By sequentially switching the input systems of input sources to determine input signals, it is possible to determine the sound data input in each input source, instead of simultaneously determining all the input sources and systems. Accordingly, the processing load at the time of outputting data including audio data or PP data as the sound data from multiple input sources can be reduced.

### CROSS-REFERENCE TO RELATED APPLICATION

This application claims the priority benefit of Japan application no. 2023-052758, filed on Mar. 29, 2023. The entirety of the above-mentioned patent application is hereby incorporated by reference herein and made a part of this specification.

### BACKGROUND

### Technical Field

The invention relates to an electronic apparatus, a sound data determination method, and a non-transitory computer readable medium.

### Description of Related Art

Patent Document 1 has disclosed to record player piano data (referred to as “PP data” in the following) in a music CD and play the music CD by using an audio playback device 30. The PP data are sound data in which a MIDI modulated signal where MIDI data are modulated is set to one of the left and right channels and an audio signal is set to the other channel.

### PRIOR ART DOCUMENT(S)

### Patent Document(s)

[Patent Document 1] Japanese Laid-open No. 2002-94593

In music CDs, in addition to those in which PP data are recorded as sound data, there are also those in which only audio signals are set as sound data in the left and right channels. Accordingly, in order to correctly play the sound data of a music CD in the audio playback device 30, it is necessary to analyze the sound data read from the music CD and determine whether such sound data are from PP data or only from audio signals.

Nevertheless, in recent days, in addition to music CDs, it is configured that sound data may be input from multiple input systems according to wireless or wired communication, and sound data may be input independently by further using the respective input systems. Thus, in order to correctly play the sound data respectively input from the input systems of the audio playback device 30, an issue arises that sound data input from all the input systems need to be constantly determined, and the processing load of the audio playback device 30 increases.

The invention provides an electronic apparatus, a sound data determination method, and a non-transitory computer readable medium capable of reducing the processing load at the time when sound data including MIDI modulated signals or audio signals from multiple input parts are output.

### SUMMARY

An aspect of the invention provides an electronic apparatus. The electronic apparatus outputs sound data formed by PP data or audio data. In the PP data, a MIDI modulated signal where MIDI data are modulated is set to one of a left channel and a right channel and an audio signal is set to an other channel. The audio data are formed by only the audio signal. The electronic apparatus includes: multiple input parts, inputting the sound data; a sequential determination part, sequentially switching a target input part among the input parts, and determining whether the sound data input from the target input part are the PP data or the audio data; a PP output part, in a case where the sound data input from the target input part are the PP data according to the sequential determination part, decoding and outputting the MIDI modulated signal in the PP data, and outputting the audio signal in the PP data; and an audio output part, in a case where the sound data input from the target input part are the audio data according to the sequential determination part, outputting the audio signal in the audio data.

Another aspect of the invention provides a sound data determination method. The sound data determination method is executed by an electronic apparatus including multiple input parts that input sound data and outputting sound data formed by PP data or audio data. In the PP data, a MIDI modulated signal where MIDI data are modulated is set to one of a left channel and a right channel and an audio signal is set to an other channel. The audio data are formed by only the audio signal. The sound data determination method includes: a sequential determination step of sequentially switching a target input part among the input parts, and determining whether the sound data input from the target input part are the PP data or the audio data; a PP output step of, in a case where the sound data input from the target input part are the PP data according to the sequential determination step, decoding and outputting the MIDI modulated signal in the PP data, and outputting the audio signal in the PP data; and an audio output part, in a case where the sound data input from the target input part are the audio data according to the sequential determination part, outputting the audio signal in the audio data.

Yet another aspect of the invention provides a non-transitory computer readable medium storing a sound data determination program. The sound data determination program is executed by a computer including multiple input units that input sound data and outputting sound data formed by PP data or audio data. In the PP data, a MIDI modulated signal where MIDI data are modulated is set to one of a left channel and a right channel and an audio signal is set to an other channel. The audio data are formed by only the audio signal. The sound data determination program causes the computer to execute: a sequential determination step of sequentially switching a target input unit among the input units, and determining whether the sound data input from the target input unit are the PP data or the audio data; a PP output step of, in a case where the sound data input from the target input unit are the PP data according to the sequential determination step, decoding and outputting the MIDI modulated signal in the PP data, and outputting the audio signal in the PP data; and an audio output step of, in a case where the sound data input from the target input unit are the audio data according to the sequential determination step, outputting the audio signal in the audio data.

### BRIEF DESCRIPTION OF THE DRAWINGS

FIG. 1 is a view illustrating the appearance of an electronic piano.

FIG. 2 is a view illustrating sound data determination.

FIG. 3 is a functional block diagram of the electronic piano.

FIG. 4 is a block diagram illustrating an electrical configuration of the electronic piano.

FIG. 5 is a flowchart illustrating a main process.

FIG. 6 is a flowchart illustrating a sequential determination process.

FIG. 7A is a flowchart illustrating a PP content determination process, and FIG. 7B is a flowchart illustrating an audio PP content determination process.

FIG. 8A is a flowchart illustrating a PP decode process, and FIG. 8B is a flowchart illustrating an audio playback process.

### DESCRIPTION OF THE EMBODIMENTS

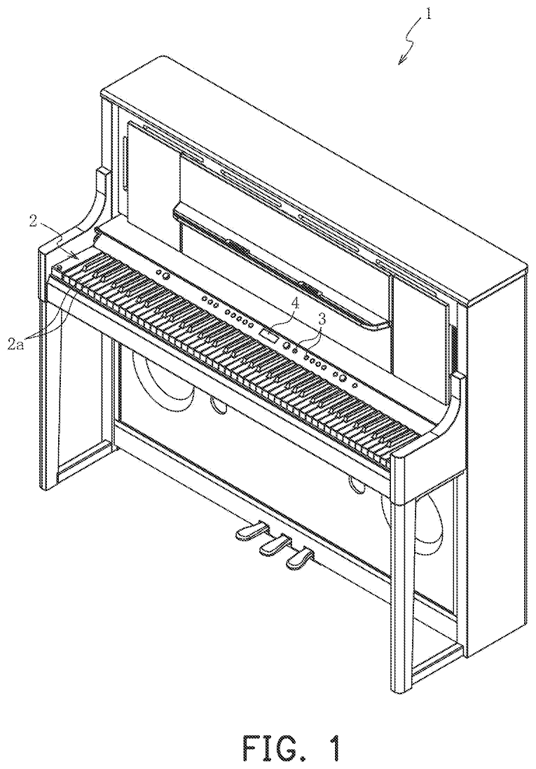

In the following, the exemplary embodiments are described with reference to the accompanying drawings. Firstly, an electronic piano 1 according to the embodiment is described with reference to FIG. 1. FIG. 1 is a view illustrating the appearance of the electronic piano 1. The electronic piano 1 is an electronic apparatus that produces musical sounds based on the performance of a user H, musical sounds based on MIDI data which are musical data under the standard of musical instrument digital interface (MIDI), or musical sounds according to playback of audio signals in sound data.

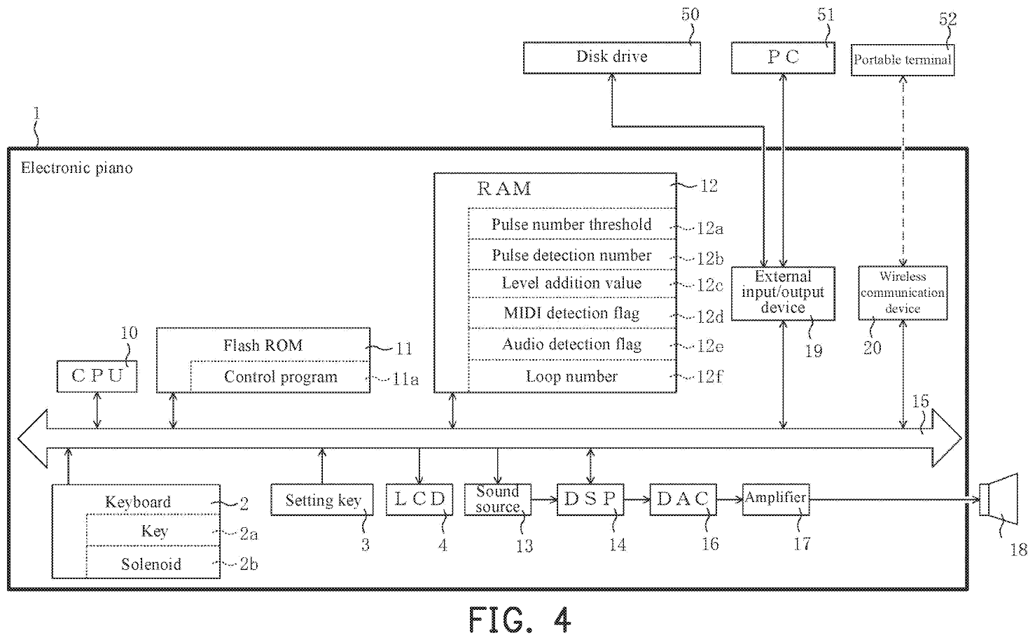

The electronic piano 1 is provided with a keyboard 2, a setting key 3, and an LCD 4. Various settings from the user H are input to the setting key 3, and setting states of the various settings are displayed on the LCD 4. The keyboard 2 is an input device for obtaining performance information according to the performance of the user H. Multiple keys 2a are arranged on the keyboard 2, and the performance information under the MIDI standard in accordance with key-pressing/key-releasing operations of the keys 2a by the user H is output to the CPU 10 (see FIG. 4) and output as musical sounds.

The keyboard 2 is further provided with solenoids 2b that respectively and independently drive the keys 2a in an upper-lower direction. In the case where note-on in the performance information is obtained from the MIDI data input from a disk drive 50, etc., to be described afterwards, the key 2a is pressed by driving the key 2a downward using the solenoid 2b. Meanwhile, in the case where note-off in the performance information is obtained from the MIDI data, the releasing of the key 2a is realized by driving the key 2a upward by using the solenoid 2b.

By synchronizing the pressing/releasing of the keys 2a according to the solenoids 2b and the production of the musical sounds according to MIDI data that are input based on the MIDI data, it may appear to the user H that the electronic apparatus 1 plays automatically. In the following, driving the solenoids 2b and operating the keys 2a based on such MIDI data is referred to as “automatic operation of the keys 2a”.

The electronic piano 1 according to the embodiment is configured to be able to output musical sounds based on input sound data, in addition to outputting musical sounds by using the keyboard 2. As the input sound data, audio data and player piano data (referred to as “PP data in the following) are provided. In the audio data, audio signals are recorded in both the left and right channels. In the case where the audio data are input as the sound data, audio signals in the audio data are emitted.

In the PP data, a MIDI modulated signal in which MIDI data are modulated is set to the left channel in the sound data, and an audio signal is set to the right channel, respectively. As a means of modulating the MIDI modulated signal of the PP data according to the embodiment, pulse modulation is used. Regarding the means of modulation, various means (e.g., pulse widths used for modulation) are adopted as appropriate according to the user H creating the PP data or a manufacturer.

In the case where PP data are input as sound data, the audio signal included in the right channel of the PP data is emitted, the MIDI modulated signal included in the left channel is decoded into MIDI data and output as a musical sound, and the key 2a is further operated automatically by using the MIDI data.

In the electronic piano 1 of the embodiment, the sound data formed by the audio data or the PP data are input at arbitrary timings from multiple input sources. As the input source of the sound data, a disk drive 50 that reads sound data from an optical disk such as a music compact disk (music CD) and is connected to the electronic piano 1, a personal computer (PC) 51 connected with the electronic piano 1, and a portable terminal 52 connected with the electronic piano 1 via wireless communication are provided.

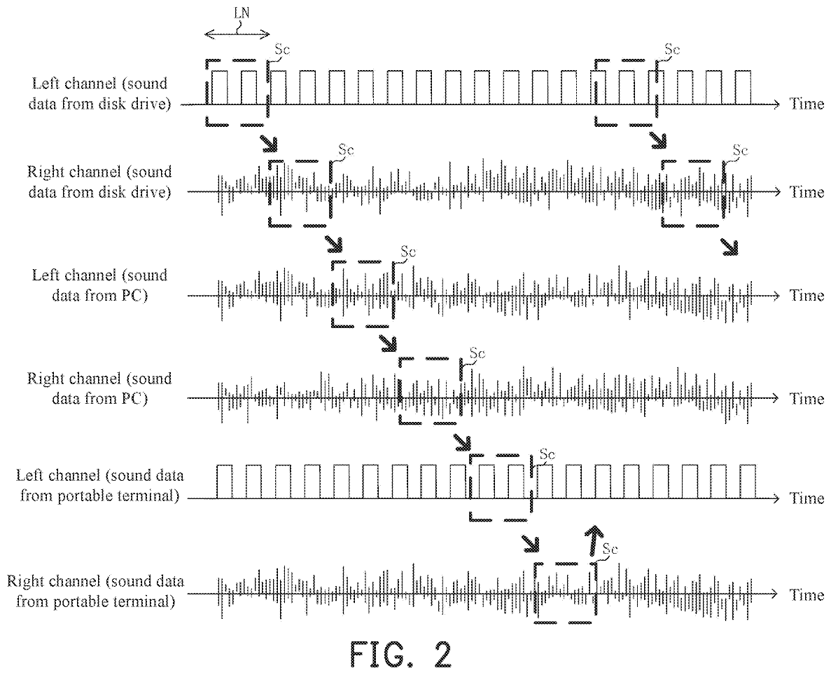

In order to correctly output the sound data input at arbitrary timings from the multiple input sources, it is necessary to constantly determine the sound data input from all the input sources. However, by doing so, the processing load of the electronic piano may increase, and the sound data may not be output with favorable response. In the embodiment, by sequentially performing sound data determination for each of the left and right channels of the sound data from the input sources, the processing load of the electronic piano 1 relating to sound data determination is reduced. Referring to FIG. 2, a sound data determination means according to the embodiment is described.

FIG. 2 is a view illustrating sound data determination. In the embodiment, for the sound data input from the disk drive 50, the PC 51, and the portable terminal 52, the left and right channels are respectively set as “input system”, and the sound data determination is sequentially performed for each input system.

Specifically, as the input system, six input systems are set, i.e., the left channel of the sound data input from the disk drive 50, the right channel of the sound data input from the disk drive 50, the left channel of the sound data input from the PC 51, the right channel of the sound data input from the PC 51, the left channel of the sound data input from the portable terminal 52, and the right channel of the sound data input from the portable terminal 52. In the following, “the left channel of the sound data input from the disk drive 50”, etc., is briefly referred to as “disk drive 50/left channel”.

The order of the input systems for determining the input signals is arranged as disk drive 50/left channel→disk drive 50/right channel→PC 51/left channel→PC 51/right channel→portable terminal 52/left channel→portable terminal 52/right channel.

As a result with the input systems determined, if the input signal is determined to be PP data or audio data, the determination of sequentially switching the input systems is stopped, and the determined input signal is output. Meanwhile, if PP data or audio data are not determined until the determination until “portable terminal 52/right channel” is performed, the determination of a signal input from the initial “disk drive 50/left channel” is repeated again. In the following, sequentially switching the input systems to determine the input signals is referred to as “sequential determination”.

The specific determination on the input signals is performed by monitoring the input signals during a predetermined time LN in a target input system. In a region Sc shown in FIG. 2, the target input system on which the determination is performed and the period thereof are respectively illustrated.

In the embodiment, a time length of 500 samples of the sound data are set for the time LN. For example, in the case where the sampling frequency of the sound data is 44.1 kHz, the time LN is set as 500/44100 seconds (about 11.3 milliseconds). It is noted that the time LN may be equal to or greater than 500 samples of the sound data, and may also be less than or equal to 500 samples.

During the time LN, the signals input by the target input system are observed, and whether a predetermined pulse width (e.g., 260 microseconds or 300 microseconds) is consecutively detected for a predetermined pulse number threshold in the signal is verified. The pulse number threshold for the sequential determination of the embodiment is set as “10” in accordance with the respective lengths of the time LN and the predetermined pulse width.

It is noted that the pulse number threshold for the sequential determination is not limited to 10, and may also be equal to or greater than 10 or equal to or less than 10. Even in the case where a value other than 10 is set for the pulse number threshold in the sequential determination, the pulse number threshold in the sequential determination may also be set to a value in accordance with the respective lengths of the time LN and the predetermined pulse width.

In addition, in the case where the pulse width is consecutively detected for the pulse number threshold, the signal input by the input system is determined as a MIDI modulated signal. In addition, the means for modulating the MIDI modulated signal is analyzed from the detected pulse width. It is noted that the analysis on the means for modulating the MIDI modulated signal adopts conventional techniques.

Meanwhile, in the case where the predetermined pulse width is not consecutively detected for the pulse number threshold in the signals input during the time LN, the absolute value of the levels of the input signals is added up (integrated), and whether the added value exceeds a predetermined level is verified. In the case where the added value exceeds a predetermined level threshold, the signals input by the input system are determined as audio signals.

In the case where the predetermined pulse width is not consecutively detected for the pulse number threshold and the added value of the levels of the input signals does not exceed the predetermined level, “signaless” where no signal is input for the input system is determined.

In the case where the signal from the input system corresponding to the left channel is a MIDI modulated signal according to the determination, the sound data input from the input source corresponding to such input system are determined as PP data, and the output of musical sounds and the automatic operation of the keys 2a according to the MIDI data obtained by decoding the MIDI modulated signal of the left channel of the PP data and the output of the audio signal of the right channel of the PP data are performed.

In addition, in the case where the signal from the input system corresponding to the left channel is an audio signal, the sound data input from the input source corresponding to such input system are determined as audio data, and the output of the audio signals of the left channel and the right channel of the audio data is performed.

In the case where “signaless” is determined in the input system corresponding to the left channel and the signal from the input system corresponding to the right channel of the same input source is an audio signal as well, the sound data input from the input source corresponding to such input system are determined as audio data, and the output of the audio signals of the left channel and the right channel of the audio data is performed.

Meanwhile, in the case where the input system corresponding to the left channel and the input system corresponding to the right channel of the same input source are signaless, it is determined that no sound data is input from the input source corresponding to the input systems, the determination of the input systems ends, and the determination is resumed for a signal input in the next input system.

In this way, by sequentially switching the input systems of multiple input sources to determine the input signals, it is possible to determine the sound data input by the respective input resources without determining all the input sources and input systems at the same time. Accordingly, the processing load at the time of outputting data including audio data or PP data as the sound data from multiple input sources can be reduced. In addition, by sequentially determining the input systems, it is possible to determine the sound data in all the input systems of multiple input sources. Accordingly, the situation in which sound data are not determined according to the input sources and the input systems can be prevented.

According to the above, when the input signals are determined as audio signals or MIDI modulated signals and the input signals are output, sequential determination is stopped. Accordingly, the processing ability of the electronic piano 1 for a process of outputting of the input signals, such as decoding the MIDI modulated signals, can be concentrated. As a result, the input signals can be output with favorable response.

In addition, in the case where the user H switches the input source of sound data, and the supply of sound data from the input source into which the sound data have been input so far is interrupted, the sequential determination is started again. Accordingly, sound data from the input source after the user H performs switching can be output without the user H operating the electronic piano 1.

Meanwhile, in the case where it is signaless in the input system corresponding to the left channel and the signal from the input system of the same input source corresponding to the right channel is an audio signal, the sound data input from the input source are determined as audio data, and the output of the audio signals of the left channel and the right channel of the audio data is performed. However, in such case, practically, although the MIDI modulated signal is set to the left channel, it also includes the situation in which the left channel is temporarily signaless at the timing when sequential determination is performed.

In addition, in sequential determination, when the user switches the sound data input from the input source to PP data after the signal of the left channel is determined as an audio signal, the signal of the left channel is switched from the audio signal to the MIDI modulated signal after sequential determination.

In such case, when the MIDI modulated signal of the left channel is output as the audio signal, the pulse signal of the MIDI modulated signal is emitted as it is, so the listener may feel uncomfortable.

Therefore, in the embodiment, even in the case where the sound data from the input source are determined as audio data, the determination on whether the sound data from the input source are audio data or PP data continues, and in the case where the audio data are PP data, the output of audio data is switched to the output of PP data. The determination performed during outputting of audio data is referred to as “in-output determination”. The means for determining sound data the in in-output determination is the same as the means for sequential determination. However, the pulse number threshold used for determining whether the input signal is a MIDI modulated signal is set to “100”.

With such in-output determination, in the case where PP data are determined as audio data in sequential determination, or even in the case where sound data from the corresponding input source are switched from audio data to PP data, the MIDI modulated signal in the PP data is suppressed from being emitted as it is. Thus, the listener's discomfort can be suppressed.

In addition, the pulse number threshold (“100”) in the in-output determination is set to be greater than the pulse number threshold (“10”) in the sequential determination. That is, in the in-output determination, the number of pulses observed to determine the signal as a MIDI modulated signal is greater. Thus, erroneous detection of the MIDI modulated signal is suppressed, and whether the signal is a MIDI modulated signal can be more correctly determined.

Meanwhile, in the sequential determination, by setting the pulse number threshold to be a value less than the value in the in-output determination, whether a signal is a MIDI modulated signal can be quickly determined. In this way, the determination can be performed quickly while switching the input systems through sequential determination.

It is noted that the pulse number threshold for in-output determination is not limited to 100, and may also be equal to or greater than 100 or equal to or less than 100. Even in the case where a value other than 100 is set for the pulse number threshold in the in-output determination, a value greater than the pulse number threshold in the sequential determination may still be set as the pulse number threshold in the in-output determination.

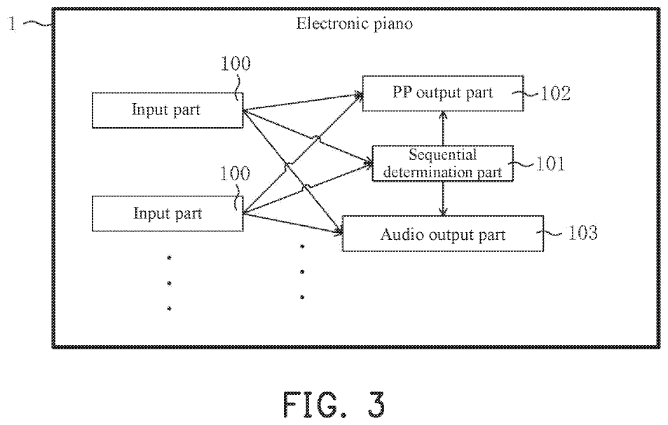

In the following, the function of the electronic piano 1 is described with reference to FIG. 3. FIG. 3 is a functional block diagram of the electronic piano 1. As shown in FIG. 3, the electronic piano 1 has an input part 100, a sequential determination part 101, a PP output part 102, and an audio output part 103.

The input part 100 is a part for inputting sound data, and is realized by using an external input/output device 19 and a wireless communication device 20 to be described afterwards with reference to FIG. 4. Multiple input parts 100 are provided in the electronic piano 1. The sequential determination part 101 is a part that determines whether the sound data input from a target input part 100 are PP data or audio data while sequentially switching the target input part 100 among the input parts 100. The sequential determination part 101 is realized by the CPU 10 to be described afterwards in FIG. 4.

The PP output part 102 is a part that decodes and outputs the MIDI modulated signal in the PP data and outputs the audio signal in the PP data in the case where the sound data input from the target input part 100 are PP data according to the sequential determination part 101. The PP output part 102 is realized by the CPU 10. In addition, the audio output part 103 outputs the audio signal in the audio data in the case where the sound data input from the target input part 100 are audio data according to the sequential determination part 101. The audio output part 103 is realized by the CPU 10.

In this way, by sequentially switching the input part 100 for determining sound data, the sound data input by each input part 100 can be determined, instead of making determination for all the input parts simultaneously. Accordingly, the processing load at the time of outputting the sound data including the MIDI modulated signal or the audio signal from the input parts 100 can be reduced. In addition, by performing sequential determination on the input parts 100, it is possible to perform determination on sound data for all the input parts 100. Accordingly, the situation in which the sound data are determined according to the input parts 100 can be prevented.

In the following, the electrical configuration of the electronic piano 1 is described with reference to FIG. 4. FIG. 4 is a block diagram illustrating the electrical configuration of the electronic piano 1. The electronic piano 1 has the CPU 10, a flash ROM 11, a RAM 12, the keyboard 2, the setting key 3, the LCD 4, a sound source 13, a digital signal processor 14 (referred to as “DSP 14” in the following), the external input/output device 19, and the wireless communication device 20. The respective components are connected via a bus line 15.

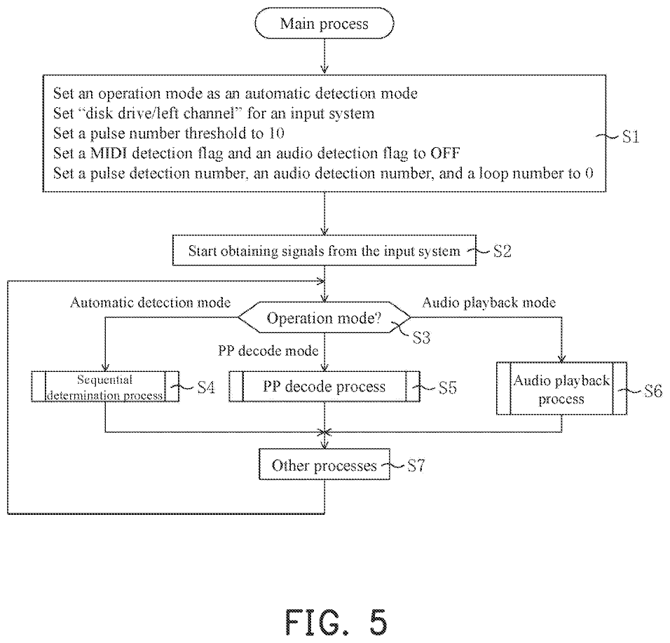

The CPU 10 is a computation device for controlling the respective parts connected by the bus line 15. The flash ROM 11 is a rewritable non-volatile memory device storing programs executed by the CPU 10 and fixed value data, and includes a control program 11a. When the control program 11a is executed by the CPU 10, a main process of FIG. 5 is executed.

The RAM 12 is a memory for rewritably storing various working data, flags, etc., when the CPU 10 executes the programs. In addition, the RAM 12 is provided with: a pulse number threshold 12a in which the pulse number threshold is stored; a pulse detection number 12b in which the number of times that the predetermined pulse width is detected consecutively from the signal input from the target input system is stored; a level addition value 12c in which an added value of the absolute values of the levels of the signals input from the target input system is stored; a MIDI detection flag 12d, in which whether a MIDI modulated signal is detected is stored; an audio detection flag 12e, in which whether the audio signal is detected is stored; and a loop number 12f in which the number of loops corresponding to the observation time of the input system in sequential determination is stored.

The sound source 13 is a device that outputs waveform data based on the performance information input from the CPU 10. The DSP 14 is an arithmetic device for performing an arithmetic process on waveform data input from the sound source 13. A digital analog converter (DAC) 16 is connected with the DSP 14, an amplifier 17 is connected with the DAC 16, and a speaker 18 is connected with the amplifier 17.

The external input/output device 19 is a device for inputting/outputting information from an external apparatus. The disk drive 50 and the PC 51 are connected with the external input/output device 19, and the external input/output device 19 receives sound data from the disk drive 50 and the PC 51. The wireless communication device 20 is a device for wireless communication with an external apparatus. The sound data from the portable terminal 52 are input via the wireless communication device 20.

In the following, the processes executed by the CPU 10 of the electronic piano 1 are described with reference to FIGS. 5 to 8B. FIG. 5 is a flowchart illustrating the main process. The main process is a process executed when the power of the electronic piano 1 is turned on.

In the main process, firstly, the operation mode of the electronic piano 1 is set as “automatic detection mode”, the input system is set to “disk drive 50/left channel”, the pulse number threshold 12a is set to 10, the MIDI detection flag 12d and the audio detection flag 12e are set to “OFF”, the pulse detection number 12b, the level addition value 12c, and the loop number 12f are respectively set to 0 (S1). As the operation mode of the electronic piano 1, “automatic detection mode” performing the sequential determination, “PP decode mode” outputting PP data, and “audio playback mode” outputting audio data are provided.

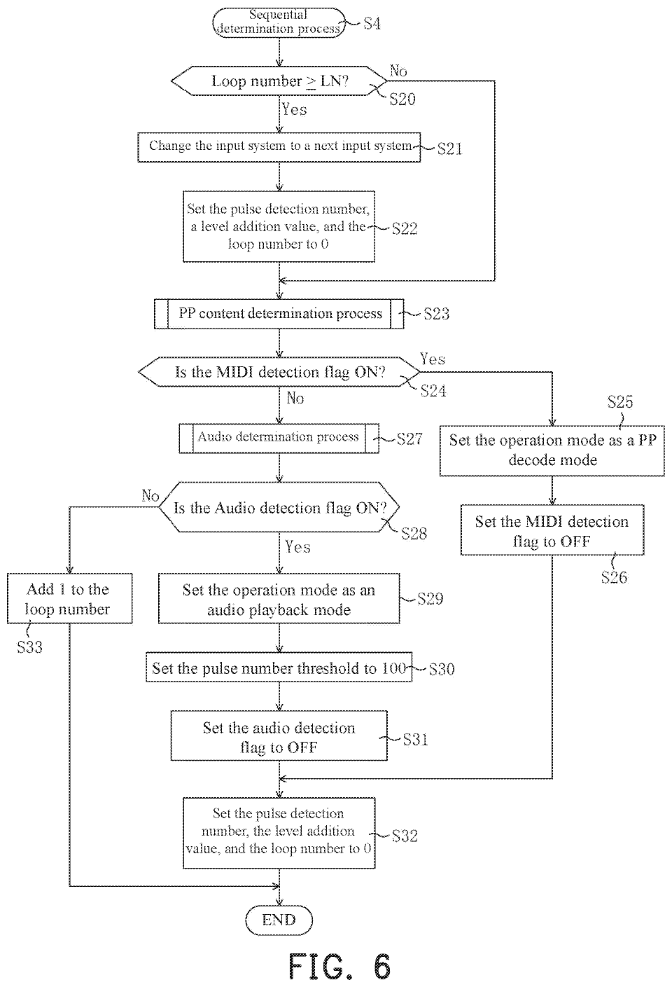

After the process of S1, obtaining of signals from the input system (i.e., “disk drive 50/left channel” set in the process of S1) is started (S2). After the process of S2, the operation mode is verified (S3). In the case where the operation mode is the automatic detection mode in the process of S3 (S3: “automatic detection mode”), a sequential determination process of S4 is performed; in the case where the operation mode is the PP decode mode (S3: “PP decode mode”), a PP decode process of S5 is performed; in the case where the operation mode is the audio playback mode (S3: “audio playback mode”), an audio playback process of S6 is performed. Referring to FIGS. 6 to 8B, the sequential determination process of S4, the PP decode process of S5, and the audio playback process of S6 are described.

FIG. 6 is a flowchart illustrating the sequential determination process. In the sequential determination process, firstly, whether the value of the loop number 12f is equal to or greater than a value corresponding to the time LN is verified (S20). After the process of S20, the input system is changed to the next input system (S21), and the loop number 12f is set to 0 (S22).

That is, since the monitoring and determination according to a PP content determination process of S23 and an audio determination process of S27 to be described afterwards for the signal of the target input system have continued for the time LN, the target input system is switched to the next input system. The order of the input systems to be determined, as described above, is arranged as follows: disk drive 50/left channel→disk drive 50/right channel→PC 51/left channel→PC 51/right channel→portable terminal 52/left channel→portable terminal 52/right channel.

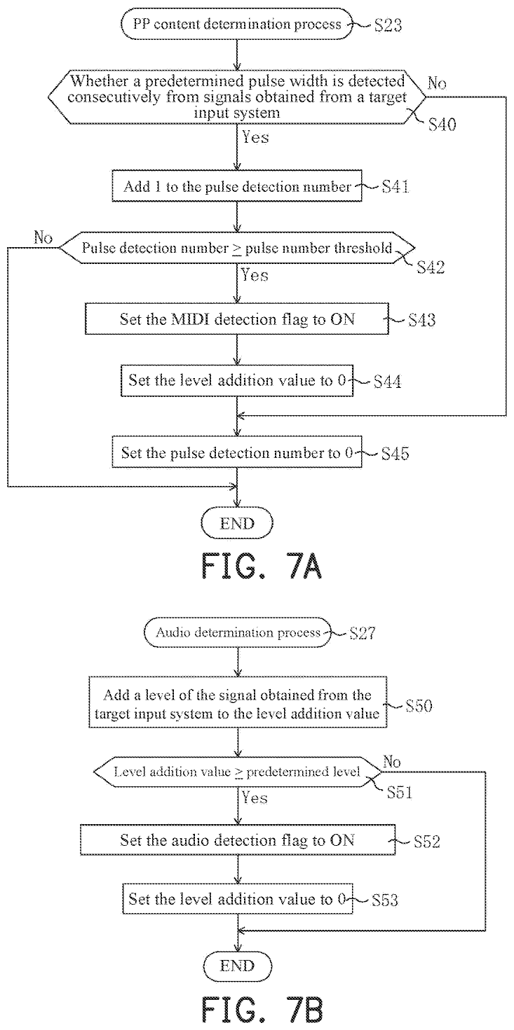

After the process of S22, or in the case where the value of the loop number 12f is less than the value corresponding to the time LN (S20: No), the PP content determination process of S23 is executed. Referring to FIG. 7A, the PP content determination process is described.

FIG. 7A is a flowchart illustrating the PP content determination process. In the PP content determination process, firstly, whether the predetermined pulse width (e.g., 0.2 milliseconds or 0.3 milliseconds) is consecutively detected from the signal obtained from the target input system is verified (S40). More specifically, whether the predetermined pulse width is detected for the first time from the target input system or whether the predetermined pulse width is consecutively detected is verified.

In the process of S40, in the case where the predetermined pulse width is detected from the signal obtained from the target input system (S40: Yes), 1 is added to the pulse detection number 12b. After the process of S41, whether the value of the pulse detection number 12b is equal to or greater than the pulse number threshold 12a is verified (S42). In the process of S42, in the case where the value of the pulse detection number 12b is equal to or greater than the value of the pulse number threshold 12a (S42: Yes), since it is determined that the signal obtained from the target input system is a MIDI modulated signal, the MIDI detection flag 12d is set to ON (S43). After the process of S43, the level addition value 12c is set to 0 (S44).

In the process of S40, in the case where the predetermined pulse width is not consecutively detected from the signal obtained from the target input system (S40: No), or, after the process of S44, the pulse detection number 12b is set to 0. In the process of S42, in the case where the value of the pulse detection number 12b is less than the value of the pulse number threshold 12a, or, after the process of S45, the PP content determination process ends.

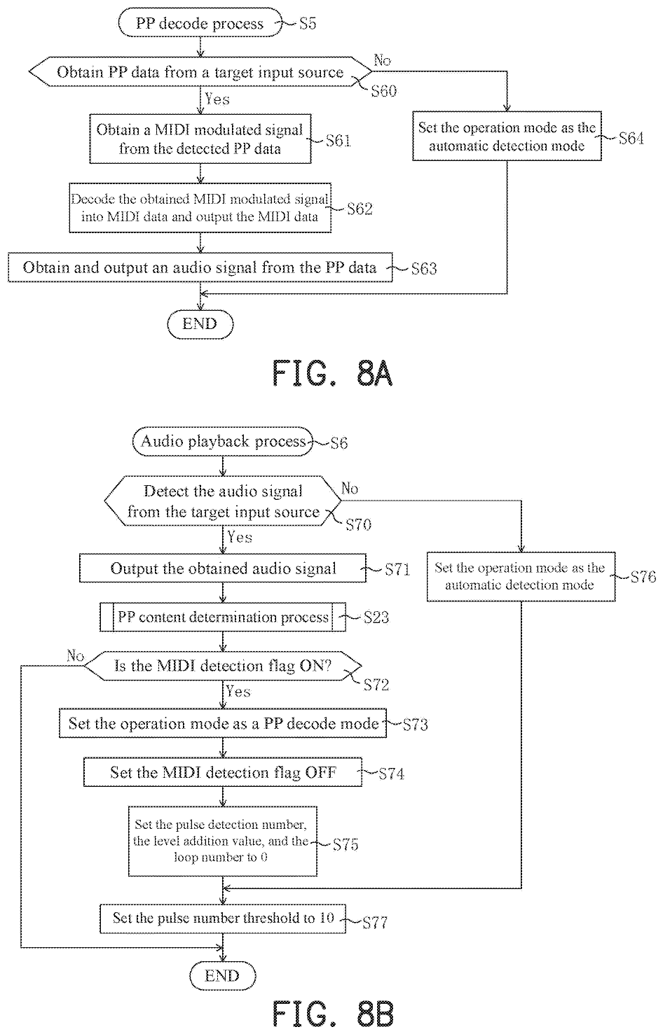

Then, the flow returns to FIG. 6. After the PP content determination process of S23, whether the MIDI detection flag 12d is ON is verified (S24). In the process of S24, in the case where the MIDI detection flag 12d is ON (S24: Yes), the operation mode is set as “PP decode mode” (S25), and the MIDI detection flag 12d is set to OFF. Accordingly, in the PP content determination process of S23, the MIDI modulated signal, i.e., the sound data of the input source corresponding to the target input system and determined as PP data, is output in the PP decode process of S5 to be described in FIG. 8A.

In the process of S24, in the case where the MIDI detection flag 12d is OFF (S24: No), the audio determination process of S27 is executed. Here, the audio determination process of S27 is described with reference to FIG. 7B.

FIG. 7B is a flowchart illustrating the audio determination process. In the audio determination process, firstly, the absolute value of the signal obtained from the target input system is added to the level addition value 12c (S50). After the process of S50, whether the level addition value 12c is equal to or greater than the predetermined level is verified (S51).

In the process of S51, in the case where the level addition value 12c is equal to or greater than the predetermined level (S51: Yes), the audio detection flag 12e is set to ON (S52), and the level addition value 12c is set to 0. In the process of S51, in the case where the level addition value 12c is less than the predetermined level (S51: No), or after the process of S53, the audio determination process ends.

Then, the flow returns to FIG. 6. After the audio determination process of S27, whether the audio detection flag 12e is ON is verified (S28). In the process of S28, in the case where the audio detection flag 12e is ON (S28: Yes), the operation mode is set as “audio playback mode” (S29), the pulse number threshold 12a is set to 100, and the audio detection flag 12e is set to OFF (S31). Accordingly, in the audio determination process of S27, the audio signal, i.e., the sound data of the input source corresponding to the target input system and determined as audio data, is output in the audio playback process of S6 to be described in FIG. 8B.

After the processes of S26, S31, the level detection number 12b, the level addition value 12c, and the loop number 12f are set to 0 (S32). In the process of S28, in the case where the audio detection flag 12e is OFF (S28: No), 1 is added to the loop number 12f (S33). After the processes of S32, S33, the sequential determination process ends.

In the following, the PP decode process of S5 is described with reference to FIG. 8A. FIG. 8A is a flowchart illustrating the PP decode process. In the PP decode process, firstly, whether PP data are detected as sound data from the target input source, that is, the input source (the disk drive 50, the PC 51, or the portable terminal 52) corresponding to the input system to which the MIDI modulated signal is input according to the PP content determination process of S23 is verified (S60).

In the process of S60, in the case where PP data are detected (S60: Yes), the MIDI modulated signal of the detected PP data is obtained (S61), and the obtained MIDI modulated signal is decoded into MIDI data and output (S62). In the process of S62, the decoded MIDI data are output as musical sounds. Moreover, the keys 2a are automatically operated by using the MIDI data. After the process of S62, the audio signal of the detected PP data is obtained, and the obtained audio signal is emitted (S63).

In the process of S60, in the case where PP data are not detected from the target input source (S60: No), for example, in the case where the input of PP data from the target input source is interrupted, or in the case where the output of the MIDI data or the audio signal obtained from PP data fails in the process of S62 or S63, the operation mode is set as “automatic detection mode” (S64) to perform the sequential determination process of S4 again. After the processes of S63, S64, the PP decode process ends.

In the following, the audio playback process of S6 is described with reference to FIG. 8B. FIG. 8B is a flowchart illustrating the audio playback process. In the audio playback process, firstly, whether audio data are detected as the sound data from the target input source, that is, the input source corresponding to the input system to which the audio signals are input according to the audio determination process of S27, is verified (S70).

In the process of S70, in the case where audio data are detected (S70: Yes), the audio signal of the detected audio data is obtained, and the obtained audio signal is output (emitted) (S71). After the process of S71, the PP content determination process of S23 is executed.

After the PP content determination process of S23, whether the MIDI detection flag 12d is ON is verified (S72). In the process of S72, in the case where the MIDI detection flag 12d is ON (S72: Yes), PP data are input from the target input source. Therefore, to perform the PP decode process of S5, the operation mode is set as “PP decode mode” (S73), the MIDI detection flag 12d is set to OFF n (S74), the pulse detection number 12b, the level addition value 12c, and the loop number 12f are set to 0 (S75).

In the process of S70, in the case where audio data are not detected (S70: No), for example, in the case where the input of audio data from the target input source is interrupted, or in the case where the output of the audio signal in the process of S71 fails, the operation mode is set as “automatic detection mode” (S76) to perform the sequential determination process of S4 again.

After the processes of S75, S76, in order to provide the sequential determination according to the next automatic detection mode, the pulse number threshold 12a is set to 10 (S77). In the process of S72, in the case where the MIDI detection flag 12d is OFF (S72: No), the audio playback process ends after the process of S77.

Then, the flow returns to FIG. 5. After the processes of S4 to S6, other processes of the electronic piano 1 are executed (S7), and the processes since S3 are repeated.

Although descriptions have been made based on the embodiment, it can be easily inferred that various modifications and changes are possible.

In the embodiment, the input sources inputting sound data are the disk drive 50, the PC 51, and the portable terminal 52. However, the invention is not limited thereto. Sound data may also be input from an input source (e.g., a sound data distribution server connected to the Internet) other than the above.

In addition, the output of musical sounds and the automatic operation of the keys 2a are not limited to being performed by using the same MIDI data. It may also be that the output of musical sounds and the automatic operation of the keys 2a are performed by using separate MIDI data. In such case, the MIDI data for outputting musical sounds and the MIDI data for performing automatic operation of the keys 2a may also be obtained from separate input sources, such as obtaining the MIDI data for outputting musical sounds from the disk drive 50, and obtaining the MIDI data for performing the automatic operation of the keys 2a from the PC 51, etc.

In the embodiment, it is configured that each channel of the left channel and the right channel of the input source is configured as an input system. However, the configuration of the input system is not limited thereto. For example, the input source may generally serve as one input system. In this case, the signals input from the left channel and the right channel of the input source may be determined in parallel, or the left channel and the right channel of the input source may also be determined alternately. In addition, multiple input sources (e.g., the disk drive 50 and the PC 51) may also be arranged as one input system.

In the embodiment, the order of the input systems to be determined is arranged as follows: disk drive 50/left channel→disk drive 50/right channel→PC 51/left channel→PC 51/right channel→portable terminal 52/left channel→portable terminal 52/right channel. However, the invention is not limited thereto. For example, the order of the input systems to be determined may be randomly changed each time.

In addition, it may also be that the numbers of times of the determined input systems are counted and stored for each input system, and the determination is performed in the order of the input systems with a greater number of times. Accordingly, since the determination is performed from the input system (input part) to which the user H inputs sound data for a greater number of times, the time lag from the time when the user H starts inputting sound data until the sound data are determined and played can be reduced.

In the embodiment, as PP data, the data where the MIDI modulated signal in which MIDI data are modulated is set to the left channel and the audio signal is set to the right channel are used. However, the invention is not limited thereto. It is also possible to use PP data in which the audio signal is set to the left channel and the MIDI modulated signal is set to the right channel. In such case, the order of input systems for determination may also be set so that the right channel is prior to the left channel (right channel→left channel).

In addition, in the embodiment, audio data are set as data in which audio signals are recorded for both of the left channel and the right channel. However, the invention is not limited thereto. As audio data, data in which the audio signal is recorded in one of the left channel and the right channel (so-called monophonic) may also be used, and data in which a channel other than the left channel and the right channel is added and the audio signal is also recorded in the channel may also be used. In the case where a channel other than the left channel and the right channel is further added, it suffices as long as the added channel is added to the input systems to be determined.

In the embodiment, the in-output determination during outputting of audio data is performed. However, the invention is not limited thereto. The in-output determination may also be performed during outputting of PP data. In addition, the in-output determination during outputting of audio data may also be omitted.

In the embodiment, whether the input signal is a MIDI modulated signal or PP data is determined by counting the predetermined width in the input signal. However, the invention is not limited thereto. For example, it may also be that, in the case where the input signal is a pulse, if the pulse is decoded after being obtained for a predetermined period and the decoded result renders valid MIDI data, such signal is determined as a MIDI modulated signal. In addition, it may also be that the pulse waveform corresponding to the MIDI modulated signal is learned from learning data, and whether an input signal is a MIDI modulated signal is determined through AI by using the learning data.

In the embodiment, the electronic piano 1 is described as an electronic apparatus. However, the invention is not limited thereto. The invention is also suitable for other electronic apparatuses, such as synthesizers or electronic wind instruments. In addition, it may also be that the control program 11a can be executed by an information processing device such as other personal computers or portable terminals.

In the embodiment. MIDI data are described as musical data. However, the invention is not limited thereto. Other music-related data not under the MIDI standard may also be used as musical data.

What is claimed is:

1. An electronic apparatus, outputting sound data formed by player piano (PP) data or audio data, wherein in the PP data, a musical instrument digital interface (MIDI) modulated signal where MIDI data are modulated is set to one of a left channel and a right channel and an audio signal is set to an other channel, and the audio data are formed by only the audio signal, the electronic apparatus comprising:
multiple input parts, inputting the sound data;
a sequential determination part, sequentially switching a target input part among the input parts, and determining whether the sound data input from the target input part are the PP data or the audio data;
a PP output part, in a case where the sound data input from the target input part are the PP data according to the sequential determination part, decoding and outputting the MIDI modulated signal in the PP data, and outputting the audio signal in the PP data; and
an audio output part, in a case where the sound data input from the target input part are the audio data according to the sequential determination part, outputting the audio signal in the audio data.

2. The electronic apparatus as claimed in claim 1, wherein in a case where the sound data are output by the PP output part or the audio output part, a determination performed by the sequential determination part is stopped.

3. The electronic apparatus as claimed in claim 1, wherein in a case where an input from the input part, which is an input of the sound data output by the PP output part or the audio output part, is interrupted, a determination by the sequential determination part is executed again.

4. The electronic apparatus as claimed in claim 1, comprising: an in-output determination part, determining whether the sound data are the PP data while the audio output part outputs the audio data, and
in a case where the sound data are determined as the PP data according to the in-output determination part, the PP output part stops outputting of the audio data by the audio output part, decodes and outputs the MIDI modulated signal in the PP data, and outputs the audio signal in the PP data.

5. The electronic apparatus as claimed in claim 4, wherein the MIDI modulated signal is a signal in which the MIDI data are subjected to pulse modulation,
the sequential determination part determines, in a case where a first predetermined number of pulses of a predetermined width are detected consecutively from the sound data, that the sound data are the PP data, and
the in-output determination part determines, in a case where a second predetermined number of the pulses of the predetermined width are detected consecutively from the sound data, that the sound data are the PP data.

6. The electronic apparatus as claimed in claim 5, wherein a value greater than the first predetermined number is set for the second predetermined number.

7. A sound data determination method, executed by an electronic apparatus comprising a plurality of input parts that input sound data and outputting sound data formed by PP data or audio data, wherein in the PP data, a MIDI modulated signal where MIDI data are modulated is set to one of a left channel and a right channel and an audio signal is set to an other channel, and the audio data are formed by only the audio signal, the sound data determination method comprising:
a sequential determination step of sequentially switching a target input part among the input parts, and determining whether the sound data input from the target input part are the PP data or the audio data;
a PP output step of, in a case where the sound data input from the target input part are the PP data according to the sequential determination step, decoding and outputting the MIDI modulated signal in the PP data, and outputting the audio signal in the PP data; and
an audio output step of, in a case where the sound data input from the target input part are the audio data according to the sequential determination step, outputting the audio signal in the audio data.

8. The sound data determination method as claimed in claim 7, wherein in a case where the sound data are output in the PP output step or the audio output step, a determination performed in the sequential determination step is stopped.

9. The sound data determination method as claimed in claim 7, wherein in a case where an input from the input part, which is an input of the sound data output in the PP output step or the audio output step, is interrupted, a determination in the sequential determination step is executed again.

10. The sound data determination method as claimed in claim 7, comprising:
an in-output determination step of determining whether the sound data are the PP data while the audio data is output in the audio output step, and
in a case where the sound data are determined as the PP data according to the in-output determination step, outputting of the audio data in the audio output step is stopped, the MIDI modulated signal in the PP data is decoded and output, and the audio signal in the PP data is output.

11. The sound data determination method as claimed in claim 10, wherein the MIDI modulated signal is a signal in which the MIDI data are subjected to pulse modulation,
in a case where a first predetermined number of pulses of a predetermined width are detected consecutively from the sound data, the sound data is determined as the PP data in the sequential determination step, and
in a case where a second predetermined number of the pulses of the predetermined width are detected consecutively from the sound data, the sound data is determined as the PP data in the in-output determination step.

12. The sound data determination method as claimed in claim 11, wherein a value greater than the first predetermined number is set for the second predetermined number.

13. A non-transitory computer readable medium, storing a sound data determination program, the sound data determination program being executed by a computer comprising a plurality of input units that input sound data and outputting sound data formed by PP data or audio data, wherein in the PP data, a MIDI modulated signal where MIDI data are modulated is set to one of a left channel and a right channel and an audio signal is set to an other channel, and the audio data are formed by only the audio signal, the sound data determination program causes the computer to execute:
a sequential determination step of sequentially switching a target input unit among the input units, and determining whether the sound data input from the target input unit are the PP data or the audio data;
a PP output step of, in a case where the sound data input from the target input unit are the PP data according to the sequential determination step, decoding and outputting the MIDI modulated signal in the PP data, and outputting the audio signal in the PP data; and
an audio output step of, in a case where the sound data input from the target input unit are the audio data according to the sequential determination step, outputting the audio signal in the audio data.

14. The non-transitory computer readable medium as claimed in claim 13, wherein in a case where the sound data are output in the PP output step or the audio output step, a determination performed in the sequential determination step is stopped.

15. The non-transitory computer readable medium as claimed in claim 13, wherein in a case where an input from the input unit, which is an input of the sound data output in the PP output step or the audio output step, is interrupted, a determination in the sequential determination step is executed again.

16. The non-transitory computer readable medium as claimed in claim 13, comprising:
an in-output determination step of determining whether the sound data are the PP data while the audio data is output in the audio output step, and
in a case where the sound data are determined as the PP data according to the in-output determination step, outputting of the audio data in the audio output step is stopped, the MIDI modulated signal in the PP data is decoded and output, and the audio signal in the PP data is output.

17. The non-transitory computer readable medium as claimed in claim 16, wherein the MIDI modulated signal is a signal in which the MIDI data are subjected to pulse modulation,
in a case where a first predetermined number of pulses of a predetermined width are detected consecutively from the sound data, the sound data is determined as the PP data in the sequential determination step, and
in a case where a second predetermined number of the pulses of the predetermined width are detected consecutively from the sound data, the sound data is determined as the PP data in the in-output determination step.

18. The non-transitory computer readable medium as claimed in claim 17, wherein a value greater than the first predetermined number is set for the second predetermined number.
